(19) United States
(12) Patent Application Publication
(10) Pub. No.: US 2012/0322472 A1
(43) Pub. Date: Dec. 20, 2012

(54) MULTIMEDIA MESSAGE DELIVERY PLATFORM

(75) Inventor: Marko Nordberg, Helsinki (FI)

(73) Assignee: BASCK LIMITED, Cambridge (GB)

(21) Appl. No.: 13/524,711

(22) Filed: Jun. 15, 2012

(30) Foreign Application Priority Data
Jun. 15, 2011 (GB) 1110006.2

(51) Int. Cl. H04W 4/14; G06F 15/16

(52) U.S. Cl. 455/466; 709/206

(57) ABSTRACT

A multimedia message delivery platform provides multimedia content to one or more users coupled in communication with the platform. The platform receives and stores the multimedia content, and communicates the multimedia content to the users. The users include wireless communication devices. The platform sends one or more notification messages to the users indicating availability of the multimedia content, and receives one or more response messages to the notifications messages from the users, and selectively directs the response messages to initiate supply of the multimedia content to the users, wherein the multimedia content is selected based upon information included in the notification messages. A parameter-limited regime, for example a time-limited regime, can be applied for receiving the response messages to the notification messages. Alternative multimedia content can be provided if the response messages are received outside the parameter-limited regime.

### CROSS-REFERENCE TO RELATED APPLICATIONS

This Application claims priority to United Kingdom Patent Application No. 1110006.2, filed on Jun. 15, 2011, the entire content of which is incorporated herein by reference.

### FIELD OF THE INVENTION

The present invention relates to multimedia message delivery platforms, for example for use with providing multimedia messages to mobile communication devices. Moreover, the present invention is concerned with methods of communicating multimedia messages using aforesaid platforms. Furthermore, the present invention relates to software products recorded on machine readable data storage media, wherein the software products are executable on computing hardware for implementing aforesaid methods.

### BACKGROUND

As mobile wireless communication devices have become increasingly complex and their functionality has increased, Short Messaging Service (SMS) functionality has been superseded by Multimedia Messaging Services (MMS). However, data flows associated with MMS are much greater than for SMS which places severe demands on contemporary communications infrastructure which is required to store and communicate multiple occurrences of large MMS data files. For example, it is contemporary practice when provided MMS communications to customer wireless devices to stack the MMS communications when the customer wireless devices are switched off, and then to download to the customer wireless devices when they are again activated. Moreover, such accumulation of MMS data for delivery places great demands on data storage capacity included in contemporary communications infrastructure.

Various alternative ways of supplying MMS data to customer wireless devices have been proposed. In a published United Sates patent application no. US2007/0088801A1 (Levkovitz et al.: “Device, System and Method of Delivering Targeted Advertisements Using Wireless Application Protocol”), there is described a system comprising a server which is operable to receive a request transmitted by a wireless communication device using Wireless Application Protocol (WAP) to access a WAP-page of a WAP-site. The server is operable to select an advertisement based on a property selected from a group consisting of: a property of the wireless communication device, and a property associated with a user of the wireless communication device. Moreover, the server is operable to serve the advertisement to the wireless communication device using WAP in response to the request. The advertisement comprises a code that, when executed by the wireless communication device, causes the wireless communication device to present the advertisement for a pre-defined time period, and to redirect the wireless communication device to the WAP-page after the pre-defined time period elapses.

A problem with such a conventional approach to provide MMS data via a wireless communication network is that unnecessary content multiplication in the network arises, requiring effectively that the network needs to be designed for greater data communicating capacity which increases the cost and complexity of the network. In the future, it is envisaged that even more complex multimedia content will need to be communicated via communication networks, such that wireless communication networks risk eventually becoming saturated on account of fundamental limits on their bandwidth when trying to cope with this even more complex multimedia content.

### SUMMARY

The various embodiments of the present invention seek to provide a communication platform which is more efficiently operable to provide multicast multimedia content to users via the platform.

According to a first aspect, there is provided a multimedia message delivery platform as claimed in appended claim 1: there is provided a multimedia message delivery platform for providing multimedia content (K1, K2, . . . Kn) to one or more user coupled in communication with the platform, wherein the platform includes a data server arrangement for receiving and storing the multimedia content (K1, K2, . . . Kn), and for communicating the multimedia content (K1, K2, . . . Kn) to the one or more users, the one or more users including wireless communication devices, wherein the platform includes the data server arrangement adapted to send one or more notification messages to the one or more users indicating availability of the multimedia content (K1), and a data switching arrangement (DSW) adapted to receive one or more response messages from the one or more users in response to the one or more notification messages, and to direct the one or more response messages selectively to a portion of the data server arrangement for initiating supply of the multimedia content (K1) to the one or more users, wherein the multimedia content (K1) is selected based upon information included in the one or more notification messages sent to the one or more users.

The use of notification messages, and corresponding response messages, which are routed via a data switch to a server capable of delivering the multimedia content to the one or more users on demand, reduces a duplication of the multimedia content within the platform.

Optionally, the platform is operable to apply a parameter-limited regime in respect of the platform for receiving the one or more response messages to the one or more notification messages, and the platform is adapted to provide alternative multimedia content (K2, . . . Kn) in an event that the one or more response messages are received outside the parameter-limited regime. The parameter-limited regime includes one or more of the following limitations: time-limited, spatially location-limited, number-limited. For example, more optionally, the platform is operable to apply a time limit regime in respect of the platform for receiving the one or more response messages to the one or more notification messages, and the platform is adapted to provide alternative multimedia content (K2, . . . Kn) in an event that the one or more response messages are received temporally outside the time limit regime.

Optionally, the platform is operable to track progression of the one or more notification messages, the one or more response messages and the multimedia content (K1) for generating one or more multimedia content dissemination reports for one or more suppliers of the multimedia content (K1).

Optionally, the platform is operable, such that the one or more notification messages are communicated as one or more SMS messages. More optionally, the platform is operable to provide the SMS messages in a manner such they are not presented to the one or more users.

Optionally, the platform is operable, such that the one or more response messages are one or more GET messages implemented using HTTP message format with URL. More optionally, the platform is operable, such that the HTTP message format includes an indicator identifying one or more servers adapted to provide the multimedia content (K1) to the one or more users which have requested the multimedia content (K1) in their the one or more response messages.

Optionally, the platform is operable to translate wireless specific protocol (WAP) messages to HTTP format for retrieving the multimedia content (K1).

Optionally, the platform is operable to provide over-the-air (OTA) support to the one or more users in an event that their communication devices are inappropriately configured to send the one or more response messages and/or receive the one or more notification messages and/or receive the multimedia content (K1).

Optionally, the platform includes a short messaging service center (SMSC), a multimedia content server (BMS), a multimedia message service center (MMSA), and a communication data switch (DSW),

wherein the short messaging service center (SMSC) is adapted to receive notification from a content provider (AD EXEC) regarding availability of multimedia content (K1) and to generate the one or more notification messages for the one or more users,

the multimedia message service center (MMSC) is adapted to be selectively coupled via the communication data switch (DSW) to the one or more users,

the multimedia content server (BMS) is adapted to be selectively coupled via the communication data switch (DSW) to deliver the multimedia content (K1) to the one or more users responding with response messages, and

the multimedia content server (BMS) is adapted to communicate with the short messaging service center (SMSC) for indicating availability of the multimedia content (K1) at the multimedia content server (BMS).

According to a second aspect, there is provided a method of operating a multimedia message delivery platform for providing multimedia content (K1, K2, . . . Kn) to one or more users coupled in communication with the platform, wherein the platform includes a data server arrangement for receiving and storing the multimedia content (K1, K2, . . . Kn), and for communicating the multimedia content (K1, K2, . . . Kn) to the one or more users, the one or more users including wireless communication devices, comprising:
(a) using the server arrangement to send one or more notification messages to the one or more users indicating availability of the multimedia content (K1);
(b) using a data switching arrangement (DSW) for receiving one or more response messages from the one or more users in response to the one or more notifications messages; and
(c) directing the one or more response messages selectively to a portion of the servers for initiating supply of the multimedia content (K1) to the one or more users, wherein the multimedia content (K1) is selected based upon information included in the one or more notification messages sent to the one or more users.

Optionally, the method includes applying a parameter-limited regime in respect of the platform for receiving the one or more response messages in response to the one or more notification messages, and using the platform to provide alternative multimedia content (K2, . . . Kn) in an event that the one or more response messages are received outside the parameter-limited regime. More optionally, the method includes applying a time limit regime in respect of the platform for receiving the one or more response messages in response to the one or more notification messages, and using the platform to provide alternative multimedia content (K2, . . . Kn) in an event that the one or more response messages are received temporally outside the time limit regime.

Optionally, the method includes tracking progression of the one or more notification messages, the one or more response messages and the multimedia content (K1) for generating one or more multimedia content dissemination reports for one or more suppliers of the multimedia content (K1).

Optionally, the method includes communicating the one or more notification messages as one or more SMS messages.

Optionally, the method includes communicating the one or more response messages as one or more GET messages implemented using HTTP message format with URL. More optionally, the method includes arranging for the HTTP message format to include an indicator identifying one or more servers adapted to provide the multimedia content (K1) to the one or more users which have requested the multimedia content (K1) in their the one or more response messages.

Optionally, the method includes translating wireless specific protocol (WAP) messages to HTTP format for retrieving the multimedia content (K1).

Optionally, the method includes providing over-the-air (OTA) support to the one or more users in an event that their communication devices are inappropriately configured to send the one or more response messages and/or receive the one or more notification messages and/or receive the multimedia content (K1).

Optionally, the method includes arranging for the platform to include a short messaging service center (SMSC), a multimedia content server (BMS), a multimedia message service center (MMSA), and a communication data switch (DSW),

wherein the short messaging service center (SMSC) is adapted to receive notification from a content provider (AD EXEC) regarding availability of multimedia content (K1) and to generate the one or more notification messages for the one or more users, the multimedia message service center (MMSC) is adapted to be selectively coupled via the communication data switch (DSW) to the one or more users,

the multimedia content server (BMS) is adapted to be selectively coupled via the communication data switch (DSW) to deliver the multimedia content (K1) to the one or more users responding with response messages, and

the multimedia content server (BMS) is adapted to communicate with the short messaging service center (SMSC) for indicating availability of the multimedia content (K1) at the multimedia content server (BMS).

According to a third aspect, there is provided a software product recorded on machine-readable data storage media, characterized in that the software product is executable on computing hardware for implemented a method pursuant to the second aspect.

It will be appreciated that features of various embodiments of the invention are susceptible to being combined in various combinations without departing from the scope of the invention as defined by the appended claims.

### DESCRIPTION OF THE DRAWINGS

Embodiments of the present invention will now be described, by way of example only, with reference to the following diagrams wherein:

FIG. 1 is an illustration of a multimedia message delivery platform pursuant to an embodiment of the present invention;

FIG. 2 is an illustration of communication steps executed during operation of the platform of FIG. 1; and

FIG. 3 is an illustration of reporting states arising in operation within the platform of FIG. 1.

In the accompanying diagrams, an underlined number is employed to represent an item over which the underlined number is positioned or an item to which the underlined number is adjacent. A non-underlined number relates to an item identified by a line linking the non-underlined number to the item. When a number is non- underlined and accompanied by an associated arrow, the non-underlined number is used to identify a general item at which the arrow is pointing.

### DETAILED DESCRIPTION

The various embodiments are concerned with a multimedia message delivery platform, namely a platform for addressing a growing desire to deliver multimedia messages to user communication devices, for example personal digital assistants (PDA's), wireless mobile telephones, smartphones, tablet-type telephones and similar. A contemporary problem with multimedia messages is that associated data storage requirements and data flows are considerably greater than those associated with short messaging service (SMS) communications. Such larger data storage and data flow requirements place severe demands on wireless communications networks, thereby increasing their cost when adapted, pursuant to conventional approaches, to accommodate additional data traffic associated with multimedia messages.

In overview, mobile messaging media with associated multicast message delivery demands specific communication network usage and service characteristics in order to provide users of wireless communication devices with a satisfactory multimedia experience. Such network usage and service characteristics are quite different to those presently possible to provided via contemporary peer-to-peer network configurations. The multimedia message delivery platform has been designed to provide certain important benefits to both communication network operators as well as an experience of recipients of mobile messaging media.

The multimedia message platform employs multicasting which is capable of removing, or at least reducing, content multiplication within a given communication network. In other words, one multimedia content item appears in a communication network only once, even when delivered to hundreds of thousands of recipients; such lack of duplication is capable of reducing data loads on communication networks, for example networks supported Internet Protocol (IP). When large portion of multicast multimedia messages are not causing loading on multimedia message service centers (MMSC), multimedia message service (MMS) capacity demands, arranged via various licenses, are considerably lower. Moreover, no impact is caused on peer-to-peer message quality when multimedia content is being communicated pursuant to the techniques described herein. “Over the air” (OTA) handset support is possible for users of wireless communication devices to cope with settings issues, despite multimedia content not being fetched after an initial message (SI) indicating availability of the content has been successfully sent and received. Moreover, intelligent content selection is provided, namely by separating SI message delivery and multicast multimedia content download separately in a way that final content to be served can be selected by users of wireless devices at a time of content retrieval in contradistinction to conventional approaches which select content to be served at a time of multimedia message service submission, namely provided multicast multimedia content to a multimedia message service center (MMSC). A delivered multimedia content version delivered to users of wireless communication devices, for example wireless handsets, can be adapted to be compatible with capabilities and functionality of the wireless communication devices.

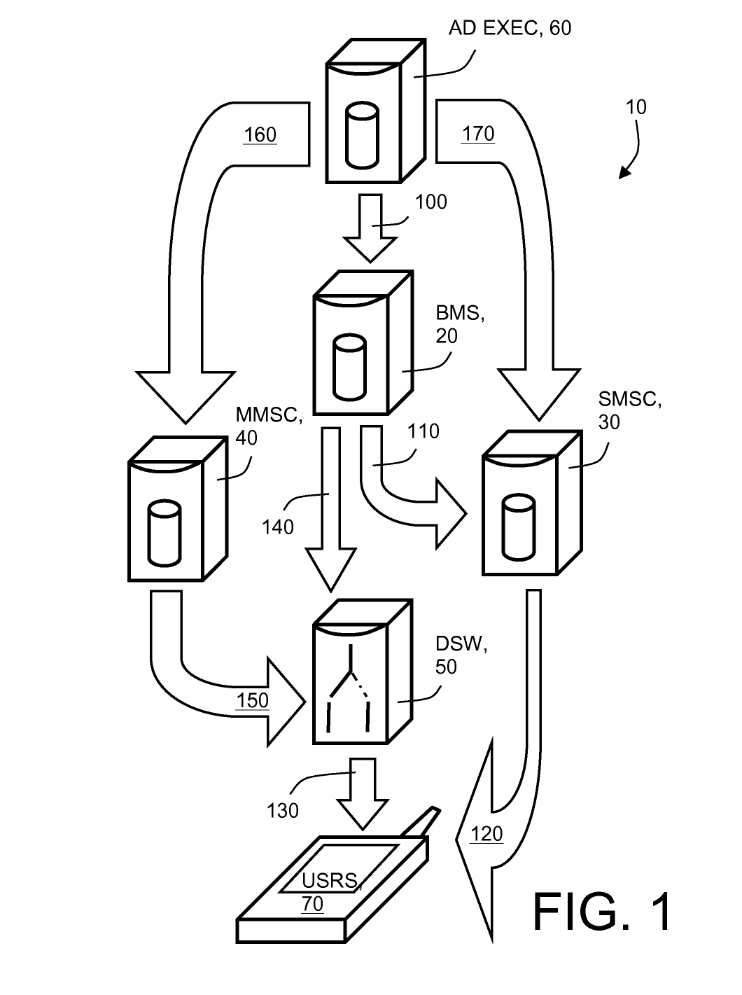

Referring to FIG. 1, a multimedia message delivery platform in accordance with one embodiment is indicated generally by 10. The platform 10 includes a control server arrangement (BMS) 20, for example a proprietary Blyk-type media server arrangement, a conventional short messaging service center (SMSC) 30, a conventional multimedia message service center (MMSC) 40, and a communications data switch (DSW) 50. The platform 10 is operable to interface to one or more contact sources, for example a source of advertising campaign content server (AD EXEC) 60. Moreover, the platform 10 is also operable to deliver a multimedia content supply service to one or more users (USRS) 70, for example to one or more wireless telephone users.

In the platform 10, the control server arrangement (BMS) 20, the short messaging service center (SMSC) 30 and the multimedia message service center (MMSC) 40 are arranged to receive data, including multimedia content, from the content server (AD EXEC) 60. The communications data switch (DSW) 50 is operable to direct in a selective manner data flows from the control server arrangement (BMS) 60 and the multimedia message service center (MMSC) 40 to the one or more users (USRS) 70. Moreover, the platform 10 is operable to provide data flows from the short messaging service center (SMSC) 30 to the one or more users (USRS) 70.

The advertising campaign content server (AD EXEC) 60 is operable, for example, to run advertising campaigns, and is concerned with routing and sending of Blyk Media Messages (BMM). The control server arrangement (BMS) 20 is operable to function as a server for providing Blyk Media Messages (BMM).

The communications data switch (DSW) 50 is beneficially implemented as a server capable of performing layer-7 switching or performing HTTP proxying. Layer-7 switching is conventionally known by many different names and associated functionality is often described by one or more of the following expressions used in the technical art: “content switch”, “layer-7 switch”, “web switch”, “reverse proxy”, content-aware switch“, “content-smart switch”, “application switch”, “service aware network node”, “multi-service proxy”, “WAP gateway”, “transparent proxy server”, “application firewall”, “packet content scanning”, “layer-7 filtering”, “payload scanning”.

In FIG. 1, a communication path 100 between the content server (AD EXEC) 60 and the control server arrangement (BMS) 20 is capable of accommodating high-volume multimedia messaging; beneficially, the path 100 is optimized for conveying Blyk-type messages for which the platform 10 is arranged to handle. A communication path 110 between the control server arrangement (BMS) 20 and the short messaging service center (SMSC) 30 is beneficially implemented as a conventional standard (SMSC) interface for sending multicast multimedia (MM) notification messages to wireless communication devices, for example wireless mobile telephones of the one or more users (USRS) 70, for example for providing service indications. A communication path 120 between the short messaging service center (SMSC) 30 and the one or more users (USRS) 70 is concerned with conveying short messaging service (SMS) messages to the one or more users (USRS) 70. Moreover, a communication path 130 between the communications data switch (DSW) 50 and the one or more users (USRS) 70 is concerned with conveying HTTP/WSP requests from the one or more users (USRS) 70 for purposes of getting multimedia content; the communications data switch (DSW) 50 is employed for directing requests for multimedia content to the control server arrangement (BMS) 20 or multimedia message service center (MMSC) 40. A communication path 140 between the control server arrangement (BMS) 20 and the communication data switch (DSW) 50. Moreover, a communication path 150 between the multimedia message service center (MMSC) 40 and the communication data switch (DSW) 50 is concerned with conveying standard MMS messages from the one or more users (USRS) 70, for example reply messages from the one or more users (USRS) 70 to the advertising campaign content server (AD EXEC) 60. A communication path 160 between the content server (AD EXEC) 60 and the multimedia message service center (MMSC) 40 is concerned with standard MMS messaging between the one or more users (USRS) 70 and the advertising campaign content server (AD EXEC) 60. Lastly, a communication path 170 between content server (AD EXEC) 60 and short messaging service center (SMSC) 30 is included for conveying short messaging service (SMS) advertisement messages from the content server (AD EXEC) 60 to the one or more users (USRS) 70 and short messaging service (SMS) replies from the one or more users (USRS) 70.

In another embodiment the functionality of DSW 50 may also be implemented in the BMS 20, MMSC 40 and/or WAP Gateway. A component means that has this functionality will be the primary component means to receive requests from the phone 70 and route them to the other server if needed.

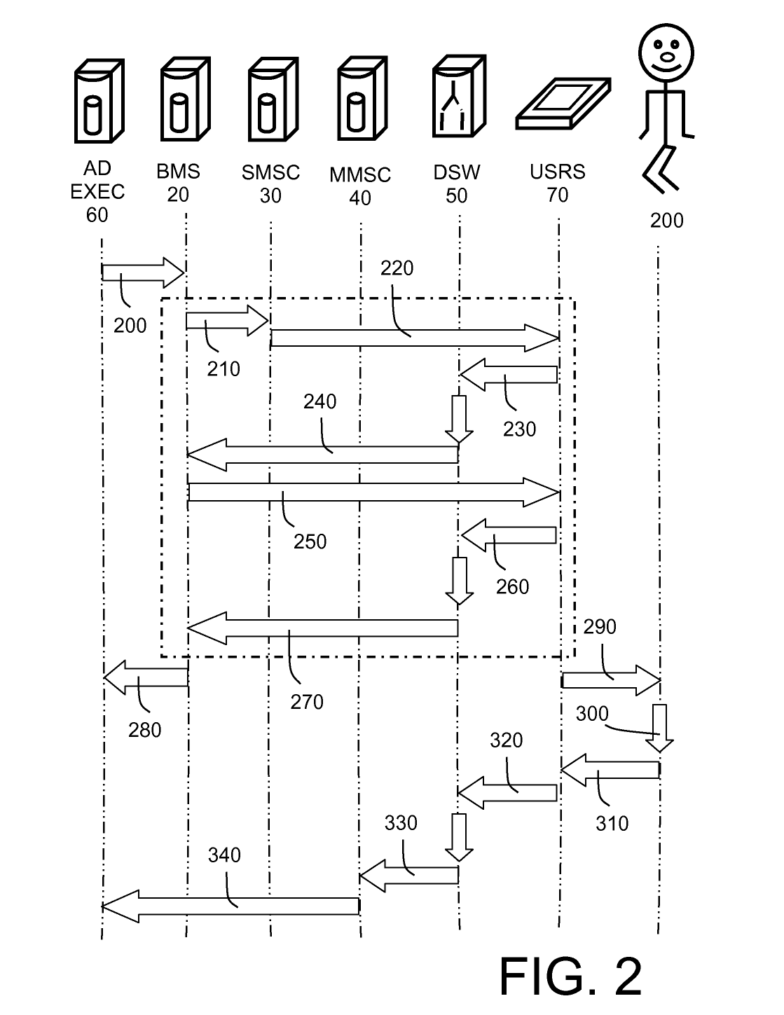

Operation of the multimedia message delivery platform 10 pursuant to the various embodiments will now be described with reference to FIG. 1 and FIG. 2. In FIG. 2, the one or more users (USRS) 70 have associated therewith one or more corresponding persons 200. In FIG. 2, there is shown a sequence of communication steps required for delivering multimedia content to the one or more users (USRS) 70. Certain of the steps (namely STEP 1 below) are executed generally for the benefit of all the users (USRS) 70, whereas other steps (namely STEPS 2 to 6 below) are executed in respect of one or more of the users (USRS) 70 for providing a multicast multimedia experience thereto. For example STEPS 2 to 6 are potentially executed for each of the one or more users (USRS) 70.

In FIG. 2, a sequence of message exchange steps occurs wherein:

STEP 1: the advertising campaign content server (AD EXEC) 60 sends a multimedia batch sending request 200 to the control server arrangement (BMS) 20 which causes relevant multimedia data content K1 to be made available at the control server arrangement (BMS) 20.

STEP 2: a multimedia notification (MN) 210 is sent from the control server arrangement (BMS) 20 to the short messaging service center (SMSC) 30 for notifying the short messaging service center (SMSC) 30 that the multimedia data content K1 is now available. In conventional contemporary communication systems, the multimedia content K1 is already fixed once the multimedia notification (MN) is received, whereas, in respect of the embodiments described herein, information in the multimedia notification (MN) can be used to tailor the multimedia data content K1 fetched, for example location information from the base station where the multimedia notification (MN) was sent from, or the number of delivered K1 messages previously delivered in an advertising campaign. Such a manner of operation is especially helpful in situations wherein wireless communication devices, for example mobile telephones, have been switched off and are subsequently turned on.

STEP 3: a corresponding short messaging service (SMS) communication 220 is sent from the short messaging service center (SMSC) 30 to at least one of the users (USRS) 70. The SMS communication 220 is optionally presented as a text invitation, alternatively by way of some graphical symbol for attracting the attention of the at least one user (USRS) 70. An intention here, for example, is to attract the attention of the at least one user (URSR) 70 to receive the multimedia content without yet having transferred any appreciable volume of data within the platform 10.

STEP 4: a “Get BLKY content” instruction 230 is sent from the at least one user (USRS) 70 to the communications data switch (DSW) 50 and directed therethrough as a corresponding message 240 to the control server arrangement (BMS) 20; for example, the a “Get BLKY content” instruction 230 is sent automatically when the at least one user (USRS) 70 switches on his/her mobile communication device, for example mobile telephone (“cell phone”). Receipt of the message 240 at the control server arrangement (BMS) 20 is indicative of the at least one user (USRS) 70 being desirous to receive the multimedia data content K1.

STEP 5: the multimedia data content K is communicated as denoted by 250 from the control server arrangement (BMS) 20 to the at least one users (USRS) 70, and a response message 260 sent from the at least one user (USRS) 70 to the communication data switch (DSW) 50 which directs the message 260 therethrough as corresponding message 270 back to the control server arrangement (BMS) 20. The messages 260, 270 ensure that the control server arrangement (BMS) 20 receives confirmation of successful delivery of the multimedia data content K1 to the at least one user (USRS) 70.

STEP 6: the control server arrangement (BMS) 20 reports via a message 280 back to the advertising campaign content server (AD EXEC) 60 that a copy of the multimedia data content K1 has been successfully provided to the at least one user (USRS) 70.

STEP 7: presentation of the multimedia data content K1 to the person 200 corresponding to the at least one user (USRS) 70, for example an animated advertisement with sound and video content, results in a prompt 290, namely a message alert, for example a graphic symbol encouraging the person 200 to touch the graphic symbol on a touch-screen or provide an equivalent form of response 300 generating a corresponding response signal 310 within the wireless communication device associated with the person 200, namely the at least one user (USRS) 70. The response signal 310 results in the at least one user (USRS) 70 sending a multicast media service (MMS) reply message 320 via the communications data switch (DSW) 50 and directed there through as a subsequent message 330 via the multimedia message service center (MMSC) 40 as a subsequent message 340 back to the advertising campaign content server (AD EXEC) 60, for example to denote interest of the person 200 to receive products and/or services as advertised by way of the data content K1.

STEP 7 only occurs if the person actually elects to respond to being presented the data content K1; alternatively, the response can be generated automatically by the one or more users (USRS) 70, for example via software applications installed on the wireless communication devices. The control server arrangement (BMS) 20, also known as a Blyk server as aforementioned, is capable of supporting a plurality of advertising campaign content servers (AD EXEC) 60. It will be appreciated that the data content K1 is only hosted at the control server arrangement (BMS) 20 and not duplicated multiple times within the platform 10 in contradistinction to convention contemporary communication networks adapted to communicate multicast multimedia data content. Such a benefit renders the platform 10 less expensive and easier to implement in comparison to contemporary known solutions.

In another embodiment, STEP 7 the message 310-340 may be sent as SMS message in which case the message goes via the SMSC 30 to the AD EXEC 60 and might not be using the MMSC 40. As a further implementation note the DSW 50 (or similar functionality in BMS or MMSC) might be needed to route messages that are not sent using the BMS 20. This can be seen in e.g. in conventional peer-2-peer messaging.

The message 220 beneficially includes certain time attributes therein, for example a time period defined from a start time and a stop time, during which the data content K1 is available for presentation at the at least one user (USRS) 70, without requiring the data content K1 needing to be downloaded to the at least one user (USRS) 70. In an event that the at least one user (USRS) 70 has not switched his/her wireless communication device to an energized active state, such that the “GET BLYK content” message 230 is not sent, for example within the aforementioned time period, the at least one user (USRS) 70 is operable to send messages 230, 240 belatedly, and the control server arrangement (BMS) 20 is operable to send alternative data content, for example data content K2. For example, the data content K2 can be an animated multimedia message presentation to the at least one user (USRS) 70 that a given discount advertising offer has now expired, but nevertheless by animation providing the at least one user (USRS) 70 with a lasting impression which will influence positively the at least one user (USRS) 70, namely the person 200, regarding making a future purchase for services and/or products. Both the content data K1 and K2 are hosted at the control server arrangement (BMS) 20. Optionally, the data content K2 is also time limited to an associated time period, such failure of the at least one user (USRS) 70 to invoke the content data K2 can result in subsequent content data K3 and so on.

Beneficially, the message 220 is geographically delimited depending upon a geographical location of the at least one user (USRS) 70. Optionally, geographical filtering of the message 230 occurs at the wireless communication device of the at least one user (USRS) 70 which is equipped with GPS and/or GPRS position detection functionality, for example via one or more software applications executing on the wireless communication device of the at least one user (USRS) 70. Such filtering is of benefit in that the control server arrangement (BMS) 20 is operable to send out the message 220 to a population of the users (USRS) 70, without needing to be aware of geographical locations of the population of the users (USRS) 70.

From an experience perspective of the at least one user (USRS) 70, the control server arrangement (BMS) 20 is capable, via the platform 10, of having a better visibility to message and multimedia content delivery, and has a real-time end-to-end communication connection to the wireless communication device of the at least one user (USRS) 70. Optionally, additional benefits are achievable including at least one of:
(a) educational messages can be triggered in an event that availability of the multimedia data content K1 is notified to the at least one user (USRS) 70 but no corresponding fetch message 230 is sent, for example educational messages encouraging the person 200 to correct MMS settings of their wireless communication device;
(b) the platform 10 makes possible data collection including message transactions, behavior of the at least one user (USRS) 70 and also setting a functional capability information describing the wireless communication device of the at least one user (USRS) 70; and
(c) additional functionalities such as over-the-air (OTA) handset settings support can be provided to the at least one user (USRS) 70, for example in a situation where settings issues arise, namely message 220 delivery despite no corresponding fetch message 230 being generated. Optionally, the control server arrangement (BMS) 20 can automatically initiate an over-the-air (OTA) recovery process and/or arrange a member education message delivery.

The platform 10 makes possible intelligent content selection, namely made possible by separating delivery of the message 220, and associated fetch message 230, from downloading of the multimedia content data K1, or one or more of K2 to Kn, wherein n is a number greater than 2. In other words, final content data to be loaded to the at least one user (USRS) 70 can be selected at e.g. a time of content retrieval, not at the time of MMS submission as occurs in conventional multimedia content communication systems. Further the retrieval of the data content K1 can be initiated based on one or more selection criteria retrieved from the notification message (210, 220), for example information such as time, number of delivered multimedia data content K1, location of the at least one user (USRS) 70, the order of the data content K1 being collected, and/or even preferences known through a profile of the at least one user (USRS) 70. All these selection criteria can be used alone or in combination as aforementioned.

Implementation of the platform 10 is rendered possible via layer-7 switching. Layer-7 switching directs requests from a wireless communication device, for example a mobile telephone (“cell phone”), to a correct defined destination, based on URL address on a HTTP request. “URL” is an abbreviation for Universal Resource Locator, and “HTTP” is an abbreviation for Hypertext Transfer Protocol. The layer-7 switch is performed in the data switch (DSW) 50. Moreover, layer-7 switching is beneficially implemented using a HTTP proxy server.

A conventional communication network is capable of being reconfigured to implement the platform 10. No changes are needed to wireless communication devices of the one or more users (USRS) 70 and existing settings are optionally employed. In other words, a wireless communication device of the at least one user (USRS) 70 would attempt to retrieve content from a standard multimedia message service center (MMSC), but the data switch (DSW) 50 in the case of the platform 10 causes the data content K1 to be sent from the control server arrangement (BMS) 20 included in the platform 10.

Examples of message form for ensuring level-7 switching within the platform 10 will now be provided. An example of the message 220 sent to the at least one user (USRS) 70 would be:

http://mmsc.operator.net:8080/mms/

A example of a standard conventional MMS request made by the at least one user (USRS) 70 would be:

GET http://mmsc.operator.net:8080/mms/SJj5pKwRDEgAAGa3AAAA0QAAAAwAAAAA HTTP/1.1

In contradistinction, an example of an MMS request made by the at least one user (USRS) 70 pursuant to one embodiment would be:

GET http://mmsc.operator.net:8080/mms/BLYK1/ft1JxHvH HTTP/1.1

It will be appreciated here that “ . . . BLYK1 . . . ” is a label which is identified by the communication data switch (DSW) 50 to indicate a routing requirement to the control server arrangement (BMS) 20, for example a Blyk-type server for providing multicast multimedia content. In this example, the level-7 routing or proxy needs to be configured so that URL addresses starting with “http://mmsc.operator.net:8080/mms/BLYK1” are routed for the Blyk media server, namely the control server arrangement (BMS) 20. The digit “1” in the signature refers to a node number of the Blyk media server in multi-node setup. When implementing the platform 10, it is not possible to employ an own host name for the Blyk media server, namely the control server arrangement (BMS) 20, on account of security considerations, wherein substantially all wireless communication devices, for example mobile telephones, reject any multimedia notification (MN) indications where the content URL does not match the URL in stored settings.

In the steps illustrated in FIG. 2, the HTTP GET message 230 is optionally accompanied by POST request messages to send “m-notifyrespind” messages. Such “m-notifyrespind” messages are used for the at least one user (USRS)70 to inform that the data content K1 was successfully retrieved, or in some cases deferred or rejected. Beneficially, the at least one user (USRS) 70, namely wireless communication device, posts such messages to a MMS homepage URL, for example the standard multimedia message service center (MMSC) 40. However, certain layer-7 data switches are not capable of directing such POST requests on account of their associated URL not including any information which could be employed for such notification purposes. Preferably, a payload associated with the POST data is investigated to make appropriate correct switching decisions at the communication data switch (DSW) 50.

In FIG. 2, it is not essential to receive POST requests; the control server arrangement (BMS) 20 of the platform 10 is capable of inferring most important information from retrievals of the data content K1, similarly the data content K2 to Kn. If POST requests are available within the platform 10, they are optionally used for tracing how many of the one or more users (USRS) 70 have a wireless communication device, for example mobile telephone, or MMS settings that cause rejections or deferred retrieval to arise. Examples of routing rules which may be employed in the platform 10 include one or more of:
(i) transmission control protocol (TCP) specifies a destination Internet protocol (IP) address and port which pertain t the MMSC 40;
(ii) an HTTP method is included in the POST and an associated URL starts with “http://mmsc.operator.net:8080/mms”;
(iii) an HTTP header includes “Content-Type: application/vnd.wap.mms-message”;
(iv) a Blyk signature “\x98BLYK1” defines binary content, wherein a byte “\x98” is a WBXML binary coding for “X-Mms-Transaction-ID”.

Alternatively, the platform 10 is implemented so that the multimedia message service center (MMSC) 40 delivers posts with BLYK transaction identification (ID) details to the control server arrangement (BMS) 20.

Optionally, the platform 10 is operable to employ wireless specific protocol (WSP) to Internet protocol HTTP translations. For example, older legacy mobile telephones (“cell phones”) are only capable of supporting earlier WAP standards, for example WAP 1.2 or earlier, and employ WAP/WSP protocol stacks and are not capable of using HTTP and TCP/IP commands. In order to support these earlier mobile telephones by way of the control server arrangement (BMS) 20, the platform 10 employs wireless specific protocol (WSP) to HTTP translation, for example a WAP gateway included within the platform 10, namely prior to the level-7 switching performed in the communication data switch (DSW) 50.

As aforementioned, the platform 10 allows for content of MMS/advertisement to be modified in case the multicast multimedia service (MMS)/advertisement is not fetched from the control server arrangement (BMS) 20 or from a multimedia message service center (MMSC), once a predetermined time has elapsed. The control server arrangement (BMS) 20 sends notification of multicast media service (MMS) to targeted users (USRS) 70 using short messaging service (SMS) notification, for example via a service indicator (SI). The targeted users (USRS) 70 fetch the multimedia service (MMS) using one or more GET instructions conveyed via wireless application protocol (WAP), for example Push Access Protocol. Depending upon the status of the targeted users (USRS) 70, for example switched off, out of coverage/reach, inactive and so forth, and an expiration of a predetermined time during which the multimedia service (MMS) is available, the content of the multimedia service (MMS) is modified and delivered to one or more of the targeted users (USRS) 70 once the targeted users (SRS) 70 have again become active. The control server arrangement (BMS) 20 is beneficially operable to host different versions of the multimedia service (MMS) as required for operation of the platform 10.

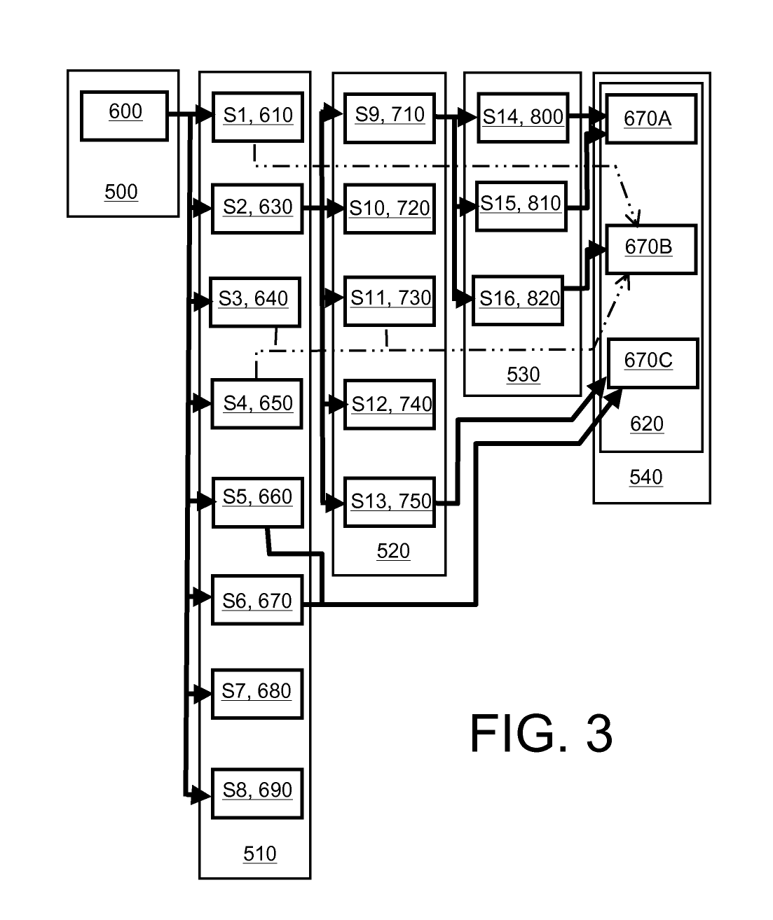

The platform 10 is beneficially operable to monitor multimedia service (MMS) delivery status and events. In FIG. 3, there is illustrated possible delivery states pertaining to a multicast multimedia service (MMS) message as handled in the aforementioned control server arrangement (BMS) 20. In FIG. 3, a first phase 500 corresponds to aforesaid STEP 1 and STEP 2, a second phase 510 corresponds to aforementioned STEP 3, a third phase 520 corresponds to aforementioned STEP 4 and STEP 5, a fourth phase 530 corresponds to aforementioned STEP 7, and a fourth phase 540 is a report generating phase to provide useful advertising campaign effectiveness information back to the content server (AD EXEC) 60; for example, the content server (AD EXEC) 60 is an advertising bureau which must, in turn, report back to its customers, for example major corporations providing consumer products and user-consumables.

In the first phase 500, there is generated a notification SMS 600 of BMS origin, namely from the control server arrangement (BMS) 20.

The second phase 510 is concerned with notification of the Blyk data content, wherein a first state denotes a connection error in respect of the control server arrangement (BMS) 20 which is compiled, if pertinent, into a final report 620 in the fifth phase 540. Moreover, the second phase 510 is also concerned with second to fifth states, namely 630 to 660 respectively. The second state 630 is concerned with the notification SMS 600 being delivered to the one or more users (USRS) 70. The third state 640 is concerned with the notification SMS 600 being temporally rejected within the platform 10 and/or the one or more users (USRS) 70 for some reason. The fourth state 650 is concerned with the notification SMS 600 being permanently rejected within the platform 10 and/or the one or more users (USRS) 70 for some reason. The fifth state 660 is concerned with the notification SMS 600 having expired. The states 630 to 660 are notified as appropriate to the fifth phase 540 for inclusion in the final report 620 and are associated with SMSC origin effects. Optionally, the final report 620 includes status indicators 670A, 670B, 670C for “success”, “failed” and “expired” respectively. The second phase 610 also includes a sixth state 680 denoting a “Timeout notification2” state 680 which is included in the report 620, as well as a seventh delayed state 690 and an “timeout notification1” eighth state 700. The seventh delayed state 690 is associated with SMSC origin effects and the sixth and eighth states 680, 700 are concerned with BMS origin effects.

The third phase 520 is concerned with retrieval of the Blyk data content, wherein a ninth state 710 denotes successful retrieval of the Blyk data content, such that successful retrieval is recorded in the final report 620; the ninth state 710 is associated with user 70 effects. A tenth state 720 denotes “Timeout retrieval1” of the Blyk data content, namely retrieval of the Blyk data content being interrupted for some reason, for example the one or more users (USRS) 70 entering into a wireless radio shadow, and is included in the final report 620; the tenth state 720 is also associated with user 70 effects. An eleventh state 730 is concerned with “TimeoutRetrieve1” and is associated with BMS 20 effects; this is also recorded in the final report 620 generated in the fifth phase 540. A twelfth state 740 is concerned with “POST deferred” and is concerned with user 70 effects. A thirteenth state 750 is concerned with a “Timeout retrieval2” which is a BMS origin effect; the thirteenth state 750 is also recorded in the final report 620 generated in the fifth phase 540.

The fourth phase 530 is concerned with a response phase in operation of the platform 10, wherein a fourteenth state 800 is associated with POST originating from the one or more users 70 being successfully retrieved by the platform 10; the fourteenth state 800 is also recorded in the aforesaid final report 620. A fifteenth state 810 is concerned with “Timeout Resp1” arising from BMS effects and is also included in the final report 620. A sixteenth state 820 is associated with a “POST error” relating to user 70 effects, and is also included in the final report 620.

The first to sixteenth states are denoted by S1 to S16 in FIG. 3. Interrelationships between the states 51 to S16 are as represented graphically in FIG. 3. The report 620 is useful for obtaining oversight of dissemination of the Blyk data content within the platform 10 and to associated one or more users 70. Thus, the report 620 provides a indication of a final delivery status of Blyk data content, for example: success, expired, failed. The final delivery data is only included once in the report 620 in respect of a given download of Blyk data content to a given user (USRS) 70.

The first phase 510, the BMS 20 submits the notification SMS 600 to the SMSC 30. After such notification, the second phase 510 starts.

The second phase 520 involves timers Notif1 and Notif2 being started. The following events potentially arise during the second phase 510:
(i) “Delivered”; origin SMSC 30; the notification SMS 600 has been delivered to the user 70 (state S2):
(ii) “Connection error”; origin BMS 20; no connection to the SMSC 30 (state S1);
(iii) “Temporary rejection”; origin SMSC 30; the SMS notification 600 has been rejected due to a temporary reason, for example a mobile telephone memory is full, and the SMSC 30 does not attempt to re-send (state S3);
(iv) “Permanent reject”; origin SMSC 30; the SMS notification 600 has been rejected due to a permanent reason, for example the given user 70 has an unknown telephone number (state S4);
(v) “Delayed”; origin SMSC 30; a temporary status for the message 600 pertains, for example when a device of the given user 70 is not turned on, and wherein the SMSC 30 continues trying to deliver the SMS notification 600 (state S7);
(vi) “Timeout Notif1”; origin BMS 20; no initial report is sent from the SMSC 30 for inclusion in the final report 620, the timer Notif1 is started at a time of submission of the SMS notification 600 and stopped by aforesaid events occurring; timeout is relatively short, for example set to a value in a range of 5 seconds to 2 minutes (state S8);
(vii) “Expired”; origin SMSC 30; a delivery of the SMS notification 600 has expired (state S5);
(viii) “Timeout Notif2”; origin BMS 20; no reports are generated by the SMSC 30 for inclusion in the final report 620; the timer for Notif2 is started at a time when the SMS notification 600 delivery occurs and is stopped by aforementioned events; the value in the timer is an expiration time for the SMS notification 600 together with a configurable safety margin (state S6).

The third phase 520, namely retrieval phase, occurs after a successful delivery of the notification SMS 600 has been executed to the one or more users (USRS) 70. In the third phase, retrieval timers Retriev1 and Retriev2 are started. The following events potentially arise during the third phase 520:
(i) “GET OK”; origin user 70; such a state concerns the BMS 20 receiving a HTTP GET request and the Blyk data content having been successfully delivered (state S9);
(ii) “GET interrupted”; origin user 70; such a state concerns the BMS 20 receiving a HTTP GET request, but retrieval of the Blyk data content is interrupted; optionally, the user 70 may attempt a retry (state S10);
(iii) “Timeout Retriev1”; origin BMS 20; such a state concerns no GET request having been started; the timer Retriev1 is started when entering the retrieval phase 520; the timer Retriev1 is optionally configured to some value in a range of 15 seconds to 30 minutes; the timer Retriev1 is stopped when the GET for the Blyk data content starts from the BMS 20 (state S11);
(iv) “POST deferred”; origin user 70; the BMS 20 receives a HTTP POST notify to confirm that the given user (USRS) 70 has received the notification SMS 600 but has not yet proceeded to retrieve the Blyk data content; in such case, the timer Retriev1 is stopped (state S12); and
(v) “Timeout Retriev2”; origin BMS 20; no Blyk data content retrieval has been commenced during a content validity period; in such case, the timer Retriev2 is the Blyk data content expiration time (state S13).

The fourth phase 540 is concerned with obtaining responses after successful retrieval of the Blyk data content has been achieved. A timer Resp1 is started at a commencement of the fourth phase 540. The following events potentially occur during the fourth phase 540:
(i) “POST retrieved; origin given user 70; the BMS 20 receives a response from the user 70 indicating that the Blyk data content has been retrieved successfully; the timer Resp1 is stopped (state S14);
(ii) “POST error”; origin given user 70; the BMS 20 receives a response from the user 70, for example mobile telephone, that some error has occurred; the timer Resp1 is then stopped (state S15); and
(iii) “Timeout Resp1”; origin BMS 20; no response has been received from the given user 70; the timer Resp1 is started after GET OK; the time Resp1 is configured to a value which is optionally in a range of 5 second to 5 minutes (state S16).

In conclusion, the platform 10 is described in the foregoing which represents an example of a manner in which an embodiment is susceptible to being implemented. The platform 10 employs the data switch (DSW) 50 and the control server arrangement (BMS) 20 to route initial SMS notifications 600 regarding availability of multicast multimedia Blyk data content K1 to one or more users (USRS) 70, to receive requests from the one or more users (USRS) 70 for the data content, to direct the requests through the data switch (DSW) 50 to cause the control server arrangement (BMS) 20 to supply the Blyk data content K1 in preference to the service center (MMSC) 40, thereby avoiding duplication of the Blyk data content K1 within the platform 10. The platform 10 employs various types of communication monitoring as illustrated in FIG. 3 for identifying whether or not the Blyk data content K1 is successfully delivered and reasons for why delivery is unsuccessful in certain situations. On account of the Blyk data content being fetched on request, failure of the one or more user (USRS) 70 to download the data content K1 within a defined time period enables the platform 10 to download alternative data content K2, K3 . . . Kn without needing to burden the platform 10 with instances of the initial data content K1. Such operation avoids the platform 10 needing to include large data buffers and therefore reduces a potential cost of constructing and maintaining the platform 10. Optionally, the Blyk data content K1 is promotional, for example advertising in nature, and the platform 10 is beneficially used to support one or more data content suppliers, namely the AD EXEC 60, and provide reports 620 thereto providing a success rate in contacting and receiving response from the one or more users 70. Such final reports 620 enabling the data providers, namely ADEXEC 60, to adapt their advertising campaigns in real time depending upon user 70 responses.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A multimedia message delivery platform (10) for providing multimedia content (K1, K2, . . . Kn) to one or more users (70) coupled in communication with the platform (10), wherein said platform (10) includes a data server arrangement (30, 40) for receiving and storing the multimedia content (K1, K2, . . . Kn), and for communicating said multimedia content (K1, K2, . . . Kn) to the one or more users (70), said one or more users (70) including wireless communication devices, wherein said platform (10) includes the data server arrangement (30) adapted to send one or more notification messages (210, 220; 600) to the one or more users (70) indicating availability of the multimedia content (K1), and a data switching arrangement (DSW) (50) adapted to receive one or more response messages (230, 240) from said one or more users (70) in response to said one or more notification messages (210, 220; 600), and to direct said one or more response messages (230, 240) selectively to a portion of the data server arrangement (20) for initiating supply of the multimedia content (K1) to the one or more users (70), wherein said multimedia content (K1) is selected based upon information included in the one or more notification messages (210, 220; 600) sent to the one or more users (70).

2. The multimedia message delivery platform (10) of claim 1, wherein said platform (10) is operable to apply a parameter-limited regime in respect of the platform (10) for receiving the one or more response messages (230, 240) to the one or more notification messages (210, 220), and said platform (10) is adapted to provide alternative multimedia content (K2, . . . Kn) in an event that said one or more response messages (230, 240) are received outside said parameter-limited regime.

3. The multimedia message delivery platform (10) of claim 2, wherein said platform (10) is operable to apply said parameter-limited regime as a time limit regime in respect of the platform (10) for receiving the one or more response messages (230, 240) to the one or more notification messages (210, 220), and said platform (10) is adapted to provide alternative multimedia content (K2, . . . Kn) in an event that said one or more response messages (230, 240) are received temporally outside said time limit regime.

4. The multimedia message delivery platform (10) of claim 1, wherein said platform (10) is operable to track progression of said one or more notification messages (210, 220; 600), said one or more response messages (230, 240) and said multimedia content (K1) for generating one or more multimedia content dissemination reports (620) for one or more suppliers of the multimedia content (K1).

5. The multimedia message delivery platform (10) of claim 4, wherein said platform (10) is adapted to monitor reply messages (310, 320, 330, 340) from said one or more users (70) in response to the one or more users (70) receiving and experiencing said multimedia content (K1), and include information derived from said reply messages (310, 320, 330, 340) in said one or more multimedia content dissemination reports (620).

6. The multimedia message delivery platform (10) of claim 1, wherein said one or more notification messages (210, 220; 600) are communicated as one or more SMS messages.

7. The multimedia message delivery platform (10) of claim 6, wherein said one or more notification messages (210, 220; 600) communicated as one or more SMS messages are not visibly presented to the one or more users (70) when received.

8. The multimedia message delivery platform (10) of claim 1, wherein said one or more response messages (230, 240) are one or more GET messages implemented using HTTP message format with URL.

9. The multimedia message delivery platform (10) of claim 8, wherein said HTTP message format includes an indicator identifying one or more servers (20) adapted to provide the multimedia content (K1) to the one or more users (70) which have requested said multimedia content (K1) in their said one or more response messages (230, 240).

10. The multimedia message delivery platform (10) of claim 1, wherein said platform (10) is operable to translate wireless specific protocol (WAP) messages to HTTP format for retrieving said multimedia content (K1).

11. The multimedia message delivery platform (10) of claim 1, wherein the platform (10) is operable to provide over-the-air (OTA) support to the one or more users (70) in an event that their communication devices are inappropriately configured to send the one or more response messages (230, 240) and/or receive the one or more notification messages (210, 220; 600) and/or receive the multimedia content (K1).

12. The multimedia message delivery platform (10) of claim 1, wherein:
the platform (10) includes a short messaging service center (SMSC) (30), a multimedia content server (BMS) (20), a multimedia message service center (MMSA) (40), and a communication data switch (DSW) (50),
the short messaging service center (SMSC) (30) is adapted to receive notification from a content provider (AD EXEC) (60) regarding availability of multimedia content (K1) and to generate said one or more notification messages for the one or more users (70),
the multimedia message service center (MMSC) (40) is adapted to be selectively coupled via said communication data switch (DSW) (50) to said one or more users (70),
the multimedia content server (BMS) (20) is adapted to be selectively coupled via the communication data switch (DSW) (50) to deliver the multimedia content (K1) to the one or more users (70) responding with response messages (230, 240), and
said multimedia content server (BMS) (20) is adapted to communicate with said short messaging service center (SMSC) (30) for indicating availability of the multimedia content (K1) at the multimedia content server (BMS) (20).

13. A method for operating a multimedia message delivery platform (10) for providing multimedia content (K1, K2, . . . Kn) to one or more users (70) coupled in communication with the platform (10), wherein said platform (10) includes a data server arrangement (30, 40) for receiving and storing the multimedia content (K1, K2, . . . Kn), and for communicating said multimedia content (K1, K2, . . . Kn) to the one or more users (70), said one or more users (70) including wireless communication devices, the method comprising:
(a) using the server arrangement (30) to send one or more notification messages (210, 220; 600) to the one or more users (70) indicating availability of the multimedia content (K1);
(b) using a data switching arrangement (DSW) (50) for receiving one or more response messages (230, 240) from said one or more users (70) in response to said one or more notifications messages (210, 220; 600); and
(c) directing said one or more response messages (230, 240) selectively to a portion of the data server arrangement (20) for initiating supply of the multimedia content (K1) to the one or more users (70), wherein said multimedia content (K1) is selected based upon information included in the one or more notification messages (210, 220; 600) sent to the one or more users (70).

14. The method of claim 13, further comprising:
applying a parameter-limited regime in respect of the platform (10) for receiving the one or more response messages (230, 240) to the one or more notification messages (210, 220), and
using said platform (10) to provide alternative multimedia content (K2, . . . Kn) in an event that said one or more response messages (230, 240) are received outside said parameter-limited regime.

15. The method of claim 14, further comprising:
applying a time-limited regime in respect of the platform (10) for receiving the one or more response messages (230, 240) to the one or more notification messages (210, 220), and
using said platform (10) to provide alternative multimedia content (K2, . . . Kn) in an event that said one or more response messages (230, 240) are received temporally outside said time-limited regime.

16. The method of claim 13, further comprising:
tracking progression of said one or more notification messages (210, 220; 600), said one or more response messages (230, 240) and said multimedia content (K1) for generating one or more multimedia content dissemination reports (620) for one or more suppliers of the multimedia content (K1).

17. The method of claim 16, further comprising:
monitoring reply messages (310, 320, 330, 340) from said one or more users (70) in response to the one or more users (70) receiving and experiencing said multimedia content (K1), and
including information derived from said reply messages (310, 320, 330, 340) in said one or more multimedia content dissemination reports (620).

18. The method of claim 13, further comprising:
communicating said one or more notification messages (210, 220; 600) as one or more SMS messages.

19. The method of claim 18, further comprising:
communicating said one or more SMS messages in a manner that they are not presented to said one or more users (70).

20. The method of claim 13, further comprising:
communicating said one or more response messages (230, 240) as one or more GET messages implemented using HTTP message format with URL.

21. The method of claim 20, wherein said HTTP message format includes an indicator identifying one or more servers (20) adapted to provide the multimedia content (K1) to the one or more users (70) which have requested said multimedia content (K1) in their said one or more response messages (230, 240).

22. The method of claim 13, further comprising:
translating wireless specific protocol (WAP) messages to HTTP format for retrieving said multimedia content (K1).

23. The method of claims 13, further comprising:
providing over-the-air (OTA) support to the one or more users (70) in an event that their communication devices are inappropriately configured to send the one or more response messages (230, 240) and/or receive the one or more notification messages (210, 220; 600) and/or receive the multimedia content (K1).

24. The method of claim 13, further comprising:
arranging for the platform (10) to include a short messaging service center (SMSC) (30), a multimedia content server (BMS) (20), a multimedia message service center (MMSA) (40), and a communication data switch (DSW) (50),
wherein
the short messaging service center (SMSC) (30) is adapted to receive notification from a content provider (AD EXEC) (60) regarding availability of multimedia content (K1) and to generate said one or more notification messages for the one or more users (70),
the multimedia message service center (MMSC) (40) is adapted to be selectively coupled via said communication data switch (DSW) (50) to said one or more users (70),
the multimedia content server (BMS) (20) is adapted to be selectively coupled via the communication data switch (DSW) (50) to deliver the multimedia content (K1) to the one or more users (70) responding with response messages (230, 240), and
said multimedia content server (BMS) (20) is adapted to communicate with said short messaging service center (SMSC) (30) for indicating availability of the multimedia content (K1) at the multimedia content server (BMS) (20).

25. A computer program product recorded on machine-readable data storage media, for operating a multimedia message delivery platform (10) for providing multimedia content (K1, K2, . . . Kn) to one or more users (70) coupled in communication with the platform (10), wherein said platform (10) includes a data server arrangement (30, 40) for receiving and storing the multimedia content (K1, K2, . . . Kn), and for communicating said multimedia content (K1, K2, . . . Kn) to the one or more users (70), said one or more users (70) including wireless communication devices, the computer program product comprising:
(a) computer readable program code operable to use the server arrangement (30) to send one or more notification messages (210, 220; 600) to the one or more users (70) indicating availability of the multimedia content (K1);
(b) computer readable program code operable to use a data switching arrangement (DSW) (50) for receiving one or more response messages (230, 240) from said one or more users (70) in response to said one or more notifications messages (210, 220; 600); and
(c) computer readable program code operable to direct said one or more response messages (230, 240) selectively to a portion of the data server arrangement (20) for initiating supply of the multimedia content (K1) to the one or more users (70), wherein said multimedia content (K1) is selected based upon information included in the one or more notification messages (210, 220; 600) sent to the one or more users (70).
